(19) United States
(12) Patent Application Publication
(10) Pub. No.: US 2026/0117911 A1
(43) Pub. Date: Apr. 30, 2026

(54) Umbilical Inspection Device

(71) Applicant: PETRÓLEO BRASILEIRO S.A. - PETROBRAS, Rio de Janeiro (BR)

(72) Inventor: Franco Costa de Castro, Vitória (BR)

(73) Assignee: PETRÓLEO BRASILEIRO S.A. - PETROBRAS, Rio de Janeiro (BR)

(21) Appl. No.: 19/363,727

(22) Filed: Oct. 21, 2025

(30) Foreign Application Priority Data
Oct. 25, 2024 (BR) 2020240222054

(51) Int. Cl. F16L 55/38; F16L 55/40; F16L 101/30

(52) U.S. Cl. CPC F16L 55/38; F16L 55/40; F16L 2101/30

(57) ABSTRACT

The present disclosure is applied in the field of non-destructive inspection of tubular structures and, more particularly, refers to an umbilical inspection device comprising: a watertight capsule having at least one camera inside the capsule, in which each camera has a lens facing a corresponding window of the capsule; at least three fins of circular cross-section fixed externally and around the capsule, in which a central fin is positioned centrally in relation to the longitudinal direction of the capsule and equidistant in relation to the fins adjacent to the central fin; and at least two sets of wheels, in which each set of wheels is fixed externally and around the watertight capsule in the vicinity of each end thereof.

### CROSS-REFERENCES TO RELATED APPLICATION

This application claims priority to Brazilian Application No. BR2020240222054 filed on October 25, 2024, the disclosure of which is expressly incorporated herein by reference in its entirety.

### FIELD OF THE INVENTION

The present disclosure relates to the field of non-destructive inspection of tubular structures and, more particularly, refers to a device (of the “pipeline inspection gauge” type – pig) for inspecting umbilicals used to perform inspections inside small diameter umbilicals to obtain high-resolution images that allow an analysis of the umbilical integrity.

### BACKGROUND OF THE INVENTION

Well intervention operations (also called “workover”) are operations necessary during their productive life, with the objective of maintaining the production or possibly improving the same. These interventions can be of the most varied types, and can even be with or without the use of rigs, and are classified as: evaluation, recompletion, restoration, cleaning, stimulation, change of the lifting method and abandonment.

In some of these well intervention operations, when a workover assembly (W/OA) connected to a wet Christmas tree (WCT) is used, the operation is said to be of the Open Sea type. In other words, a drill pipe riser (DPR) is lowered, with the workover assembly (W/OA) hanging from the string, where the operation is performed through the production/injection string in the well (main route). To access the well annulus (space between the production/injection string and the well casing), a high collapse resistant (HCR) umbilical is commonly used.

Due to the ability to operate with this umbilical empty, the same needs to resist the hydrostatic pressure relative to the water depth. This property is promoted by a metal layer (casing). The HCR umbilical is a slender, flexible element, fragile when compared to the other handling equipment of the rig (such as trolley and rig structure), and equipped with layers to resist traction forces, internal pressure and, mainly, to resist hydrostatic pressure, since the HCR umbilical is often dewatered by N₂ to provide a differential capable of breaking hydrates. Aggressive fluids required in the scope of the intervention (MEG, diesel) are also pumped through this element and it is specified to receive formation fluids (HC and gas). In addition, the operation of the completion system linked to the rig (CSLR) is complex, since it requires synchronization between the descent movement of the string versus the descent speed of the umbilical spools.

The recent history of abnormalities in umbilicals has aroused great interest in the industry and, consequently, the introduction of new inspection technologies (scanner, radiography, etc.) to verify the integrity of the umbilicals.

However, most of the solutions currently offered for inspecting umbilicals are related to specific and manual inspections of the outer diameter (using a caliper, for example). Therefore, at the slightest sign of deformation, the inspections need to be more thorough, and may suggest replacing the umbilical. The weakness of this process is that, most of the time, the system does not report a failure, and the same occurs during the operation (catastrophic failure mode). The current tools do not allow tracking the evolution of a deformation. To make matters worse, since the umbilical is covered by an external protective layer, when the failure extends to the outside, it means that the integrity of the umbilical is already condemned. On the other hand, radiography can be used to inspect a point with deformation in the external layer, but the results have shown that the deformation did not reach the internal layers. This means that it is possible to navigate in two universes, both with consequences of great impact: - disregard the signs of pronounced deformations up to the external layer and assume the risk of compromising the umbilical and losing its integrity during operation; or - consider any signs and prematurely condemn the umbilicals, under the burden of cost and scarcity of resources (manufacturing time of an umbilical: 1.5 years).

A third way would be to use the current visual inspection plan for umbilicals (measurement every 50 m or at a point of pronounced deformation), and instead of performing hydrostatic tests to approve the return of this umbilical to operation, submit it to a radiography for a more in-depth analysis. The problem is that there is no such line of inspection service for long lengths on the market. The inspections are punctual, sporadic and costly (they depend on the mobilization of equipment, isolation of areas, night work, etc.).

Considering that the HCR umbilicals are 2500 m long, punctual inspections are not feasible. The inspections using new technologies (tomography), capable of performing continuous and orbital inspections, are still in the early stages of development.

Therefore, there is a need in the state of the art for the development of a device that can perform inspections inside small diameter umbilicals to obtain high-resolution images that allow for the analysis of the integrity of this umbilical, with this device being able to move by means of a fluid pumped inside the umbilical without getting stuck in sections of the umbilical, both for configurations in which the umbilical is stretched and for configurations in which the umbilical is wound on a reel. This technique, as there is no exposure to radiation, allows inspections to be performed on site or on board the intervention rigs (independent of isolation and radiological protection). Finally, it is a quick inspection that can be performed along the entire length of the umbilicals.

The state of the art shows some documents that disclose matters within the technological field of the present disclosure.

Document US20140013872A1 discloses a pipe inspection apparatus and a method for inspecting the inner surfaces of a pipe using a pipe inspection apparatus. The pipe inspection apparatus comprises: a main body having a front end and a rear end relative to a direction of travel of the apparatus along a pipe in use; sealing means for sealing against an inner surface of the pipe, the sealing means being attached to the main body; an imaging module mounted proximate to the front end of the main body, the imaging module comprising a camera and a light source, the light source being arranged to emit light in a direction toward the inner surface of the pipe, and the camera being arranged such that, in use, the camera captures image data of the inner surface of the pipe; and control circuitry located within the main body, the control circuitry including a power supply and memory means for storing data captured by said camera. The sealing means forms a seal against the inner surface of the pipe so that, in use, a fluid flowing along the pipe applies a driving force to the pipe inspection apparatus to propel the apparatus along the pipeline.

In turn, document US20140020593A1 refers to a self-propelled autonomous pipeline tool for use in straight pipeline, comprising a first part and a second part, a hydraulic system comprising at least one hydraulic piston and means for operating the piston and a control unit. The hydraulic system is operable to retrievably separate the first and second parts of the device from each other. The hydraulic system further comprises a plurality of pipeline engaging means positioned along an outer surface of the device, which are operable by the hydraulic system to be engaged with the inner surface of the pipeline. The control unit is in communication with the hydraulic system to control the movement of the pipeline engaging means and the first and second parts, so that the pipeline tool is movable within a straight pipeline. The pipeline tool further comprises a communications module that allows the pipeline tool to use ELF (extremely low frequency) communications.

Furthermore, document EP2159574B1 discloses a device suitable for the internal inspection of pipelines, comprising a compatible outer shell around an internal housing comprising a power supply, an external electrical and logic circuit, at least one transmitter and at least one receiver connected to the exterior of the internal housing, wherein at least one receiver and at least one transmitter are electrically connected to the logic electrical circuit. This document further refers to a method for inspecting pipelines, comprising the steps of: inserting a device into a pipeline to be inspected, closing the pipeline, increasing the pressure by introducing a fluid into the pipeline on one side of the device, with the device being transported through the pipeline by a pressure difference in the fluid on each of the two sides of the device, transmitting at least a first signal from the device, receiving a second signal reflected from the walls of the pipeline, storing, recording, processing and/or transmitting the reflected signals, and controlling the speed of movement of the device by controlling the flow of the fluid.

Despite the teachings of the state of the art, it is observed that there is no teaching aimed, to date, at an inspection device capable of moving inside an umbilical (a tubular structure with a very small diameter) that is extended or rolled up on a reel, without the risk of getting stuck inside the umbilical, and being able to generate and save high-definition images of the inside of the umbilical to verify, a posteriori, the integrity thereof.

### SUMMARY OF THE INVENTION

The present disclosure falls within the technical field of non-destructive inspection of tubular structures and, more particularly, refers to a device (of the “pipeline inspection gauge” – pig) for inspecting umbilicals used to perform inspections inside small-diameter umbilicals to obtain high-resolution images that allow an analysis of the integrity of the umbilical.

According to a preferred aspect of the present disclosure, the umbilical inspection device comprises: a watertight capsule having at least one camera inside the capsule (ideally two: one facing forward and one facing backward), in which each camera has a lens facing a corresponding window of the capsule; at least three circular cross-section fins fixed externally and around the capsule, in which a central fin is positioned centrally in relation to the longitudinal direction of the capsule and equidistant in relation to the fins adjacent to the central fin; and at least two sets of wheels, in which each set of wheels is fixed externally and around the watertight capsule in the vicinity of each end thereof.

The present disclosure is applicable to various operations, such as, for example: in maintenance inspections at the base (site), in inspections carried out on board the units (rigs) with the umbilicals wound on the reel (stand by), in inspections where the device is introduced and pumped with the W/OA connected to the WCT – in this case pumping in a downward direction (Rig > HCR umbilical) and then recovered after the withdrawal maneuver, among others.

The solution of the device of the present disclosure is achieved by means of the structural configuration of its constituent elements, which bring a new configuration for positioning wheels or pulleys to stabilize the device, preferably at the ends of a watertight capsule, and a new arrangement of fins, substantially centered on the outside, which contribute to providing partial sealing and assisting in the displacement of the device. The combination of the technical features of the present disclosure leads to an obvious functional improvement, related to the fact that it allows a pig-type device to be used in a more practical and convenient manner in umbilicals with a very small diameter, of approximately 25.4 mm (1 in.), for example, taking into account HCR umbilicals with a minimum bending radius (MBR) of approximately 0.7, in which the movement of the pig device would be facilitated even in bent sections (inspection with umbilical wound on a reel).

Accordingly, these and other features and advantages of the present disclosure in face of the state of the art will clearly emerge from the detailed description below and with reference to the attached drawings, which are provided as a preferred, non-limiting aspect.

### BRIEF DESCRIPTION OF THE DRAWINGS

The preferred aspects of the present disclosure will be better understood when read in conjunction with the attached drawings. It should be understood, however, that the disclosure is not limited to the precise arrangements and instruments as shown.

Thus, the present disclosure will be described below with reference to its typical aspects and with reference to the accompanying drawings, in which:

FIG. 1 shows a schematic side sectional view of an umbilical inspection device, according to an aspect of the present disclosure.

FIG. 2 shows a schematic front view of an umbilical inspection device, according to an aspect of the present disclosure.

FIG. 3 shows a schematic view of an umbilical inspection device being displaced to the right from the fluid pumping direction, according to an aspect of the present disclosure.

FIG. 4 shows a schematic view of an umbilical inspection device being displaced to the left from the fluid pumping direction, according to an aspect of the present disclosure.

FIG. 5A shows a semicircle representing a coiled umbilical with a curved section highlighted, according to an aspect of the present disclosure.

FIG. 5B shows the isolated curved section of the umbilical, according to an aspect of the present disclosure.

FIG. 5C shows the umbilical inspection device being displaced along the curved section, according to an aspect of the present disclosure.

FIG. 6 shows the umbilical inspection device inside a small diameter umbilical, with its fins bent, according to an aspect of the present disclosure.

FIG. 7A shows an image of the interior of an umbilical with point damage in natural visible light, according to an aspect of the present disclosure.

FIG. 7B shows an image of the interior of an umbilical with point damage in infrared light, according to an aspect of the present disclosure.

FIG. 7C shows a schematic image representing an internal section of an intact umbilical, according to an aspect of the present disclosure.

FIG. 7D shows a schematic image representing an internal section of a damaged umbilical with point damage, according to an aspect of the present disclosure.

FIG. 8A shows an image of the interior of an umbilical with partial collapse in natural visible light, according to an aspect of the present disclosure.

FIG. 8B shows an image of the interior of an umbilical with partial collapse in infrared light, according to one aspect of the present disclosure.

FIG. 8C shows a schematic image representing an internal section of an intact umbilical, according to one aspect of the present disclosure

FIG. 8D shows a schematic image representing an internal section of a damaged umbilical with partial collapse, according to an aspect of the present disclosure.

### DETAILED DESCRIPTION OF THE INVENTION

As previously described, the present disclosure falls within the technical field of non-destructive inspection of tubular structures and, more particularly, refers to a device (of the “pipeline inspection gauge” type – pig) for inspecting umbilicals used to perform inspections inside small diameter umbilicals to obtain high-resolution images that allow an analysis of the integrity of the umbilical.

Initially, it is necessary to describe the development scenario of the present disclosure, which is aimed at internal inspection of umbilicals using images. The non-invasive methods and devices currently used (among which X-ray inspection and morphological analysis of umbilicals using a scanner are highlighted) have a high capacity to identify deformations and/or damage to the metallic structure of the umbilical (casing). However, a morphological analysis using a scanner is only capable of identifying deformations of the umbilical that are pronounced up to its external layer. In turn, the X-ray inspection is capable of detecting damage to the umbilical structure with a high degree of precision, but is not capable of seeing opaque elements.

Thus, the inspection device of the present disclosure is applied in internal inspection methodologies with images, which, by means of the displacement of video cameras installed internally in the device, are configured to capture images of the interior of the umbilical. Thus, the umbilical inspection device has the capacity to store high-definition images (4K or higher) to allow the interpretation of the points indicated by the external inspections (X-ray and morphological inspections). In this way, the images captured from the inspection device of the present disclosure can be used as a complementary technology to other techniques and devices (such as X-ray systems and scanners).

Thus, the present disclosure addresses to an umbilical inspection device (pig-type device) configured to generate high-definition images of the interior of the umbilical, so that the generated images can be used to observe and analyze operational abnormalities (collision, crushing, etc.) and/or damage caused by other inspection methods, such as X-ray, scanner, etc.

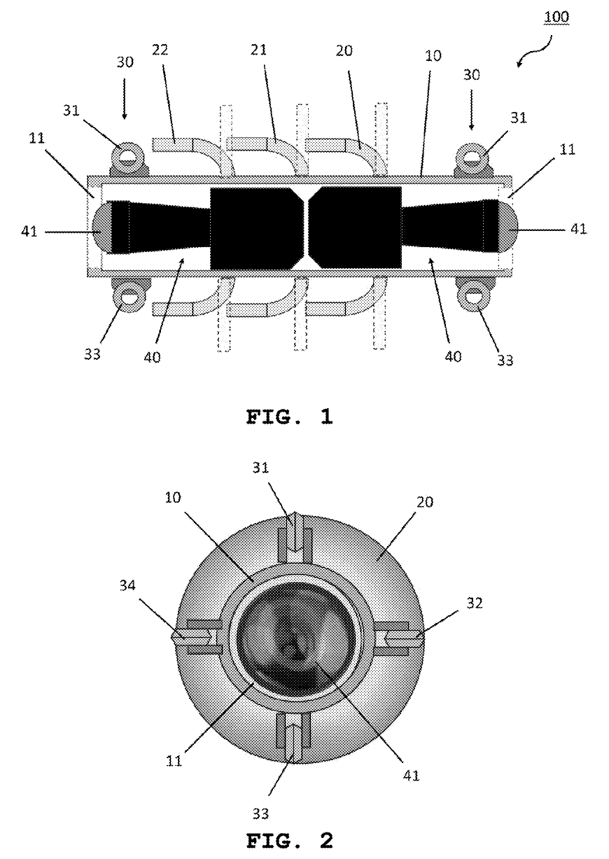

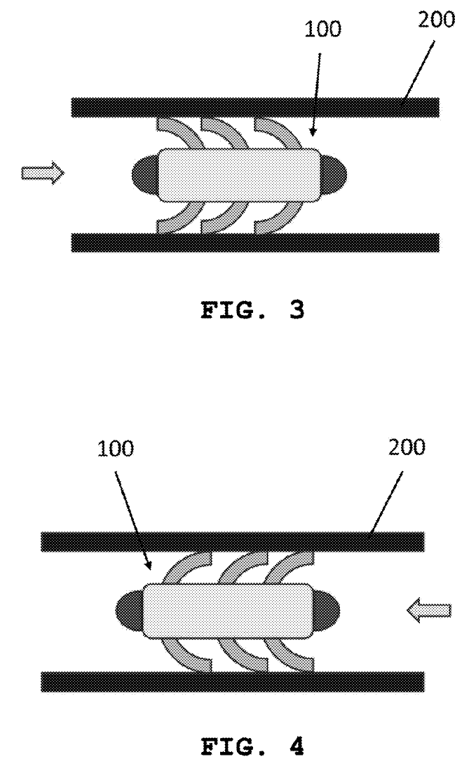

In this sense, reference is made to FIGS. 1 and 2, which show an umbilical inspection device 100, containing all its main components, according to an aspect of the present disclosure.

As can be seen in FIGS. 1 and 2, the device 100 comprises a watertight capsule 10, with a general cylindrical shape, having two windows 11, one at each end of the capsule 11. The watertight capsule 10 prevents the pumping fluid applied to move the umbilical inspection device 100 from entering the capsule 10 and affecting the components inserted therein. Furthermore, the windows 11 serve so that the lenses 41 of the cameras 40 that are inserted inside the capsule 10 pass through an opening in the window 11 and can capture images of the inside of the umbilical.

Thus, the watertight capsule 10 is configured to house at least one camera 40 inside the same, and may house up to two cameras 40. In the aspects in which the capsule 10 has two cameras 40, each camera 40 is positioned with a lens 41 facing a window 11 of the capsule 10, that is, the lenses 41 of the cameras 40 are positioned in opposite directions in relation to each other to capture images of both sides of the capsule 10.

Additionally, the umbilical inspection device 100 further comprises at least three fins 20, 21, 22 of circular general cross-section fixed externally and around the capsule 10. The central fin 21 is positioned substantially centralized in relation to the longitudinal direction of the capsule 10 and substantially equidistant in relation to the fins 20, 22 adjacent thereto. Preferably, the device 100 of the present disclosure comprises three fins 20, 21, 22; however, more or less than three fins can be used without departing from the objectives intended by the present disclosure.

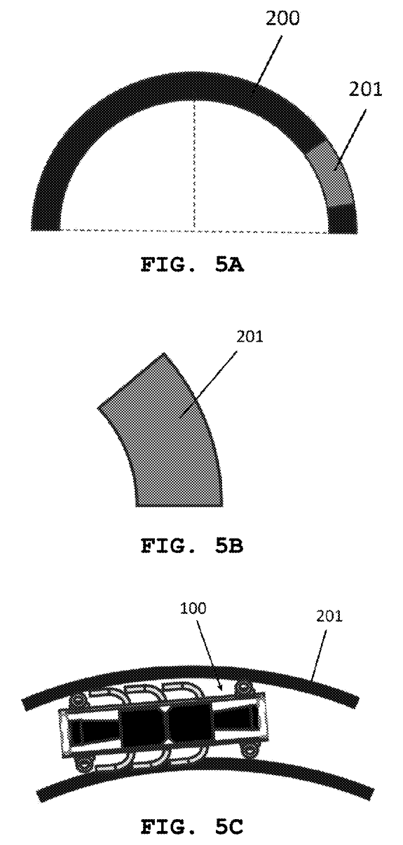

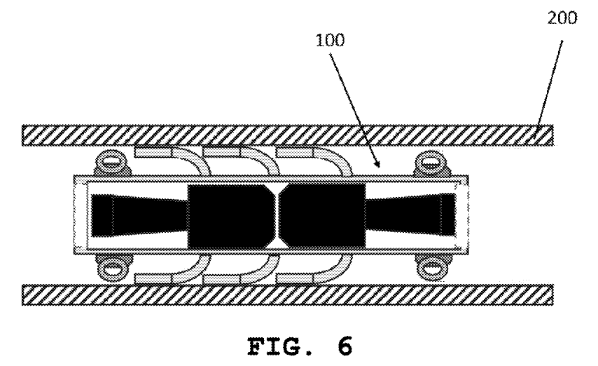

FIGS. 3 and 4 show, by way of example, the umbilical inspection device 100 of the present disclosure being displaced within an umbilical 200 depending on the flow direction of the pumped fluid, in which, in FIG. 3, the device 100 displaces to the right and, in FIG. 4, the device 100 displaces to the left. The arrows indicate the flow direction of the fluid. Thus, the umbilical inspection device 100 of the present disclosure displaces along the interior of the umbilical 200 by means of pumping fluid, preferably translucent, having a Nephelometric Turbidity Unit (NTU) of less than 30. In this sense, the fins 20, 21, 22, which are flexible membranes, act to displace the device 100 inside the umbilical 200, since the hydrostatic differential necessary to promote the displacement is obtained by means of the fins 20, 21, 22 fixed externally to the capsule 10 to provide a partial sealing (or isolation) and assist in the displacement of the device 100. It should be emphasized that the fins 20, 21, 22, being flexible, can be bent depending on the direction of fluid pumping. According to aspects of the present disclosure, the fins 20, 21, 22 are preferably made of an elastomer.

According to an aspect of the present disclosure, the device 100 further comprises at least two sets of wheels 30, wherein each set of wheels 30 is fixed externally and around the watertight capsule 10 in the vicinity of each end thereof. Preferably, each set of wheels 30 has four wheels 31, 32, 33, 34, which are distributed equidistant from each other, that is, each wheel is positioned at approximately ninety degrees in relation to another wheel adjacent to the same, as can be seen in FIG. 2.

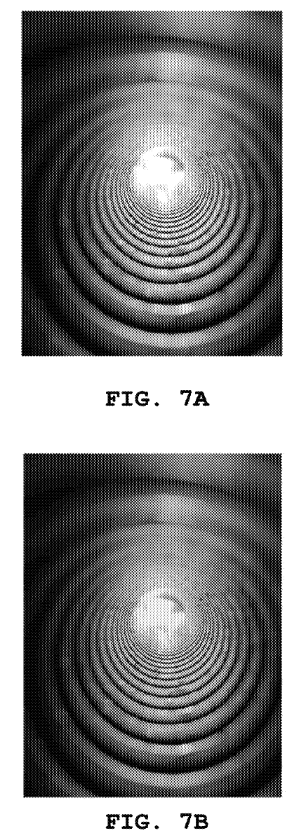

The positioning of the sets of wheels 30 at the ends of the capsule 10 is important to provide stability and centering of the device 100 when being displaced through the interior of the umbilical 200, since, when the device 100 is being displaced through curved sections of the umbilical 200 (in a configuration in which the umbilical is wound on a reel, for example), the wheels 31, 32, 33, 34 of the sets of wheels 30 come into contact with the internal walls of the umbilical 200 before other parts of the device 100 and, together with the fins 20, 21, 22, redirect the device 100 inside the umbilical 200, causing the device 100 to pass through the curved section without getting stuck. In this sense, FIGS. 5A, 5B and 5C illustrate the umbilical inspection device 100 of the present disclosure being displaced through a curved section 201 inside an umbilical 200, in which FIG. 5A shows a semicircle representing a coiled umbilical 200, FIG. 5B shows a curved section 201 of the coiled umbilical 200, and FIG. 5C represents the device 100 of the present disclosure passing through the curved section 201. It is worth emphasizing that for HCR umbilicals (with internal metal housing) there is a variable that prohibits bending of the umbilical below a specified limit. This variable is known as the minimum bend radius (MBR).

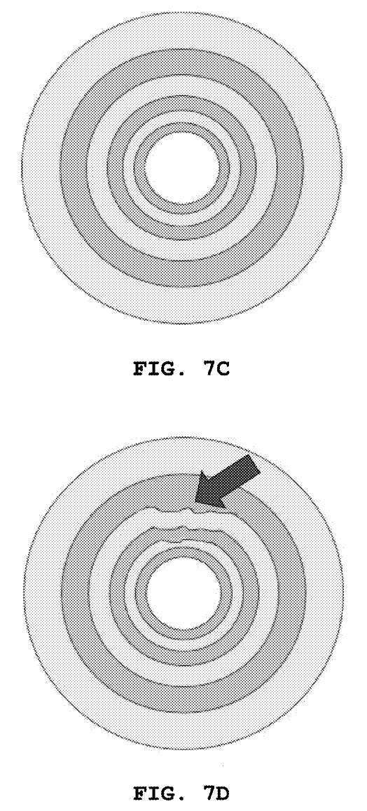

The capsule 10 of the present disclosure has an outer diameter of approximately 0.0127 m (0.5 inches), and the transverse distance between a wheel of the set of wheels and the wheel positioned 180 degrees from it is approximately 0.0190 m (0.75 inches). In this way, the device 100 of the present disclosure is configured to be used in umbilicals, preferably HCR umbilicals, which have an inner diameter of approximately 0.0254 m (1 inch) or larger. In cases where the umbilical has a diameter of 0.0254 m, the MBR is 0.7 m, which is the most restricted case. Thus, FIG. 6 illustrates, by way of example, the device 100 of the present disclosure inserted in an umbilical 200 with its flexible fins bent while being displaced by means of fluid pumping.

The device 100 of the present disclosure further comprises an image storage medium (not shown), such as a non-volatile memory card, for storing the images captured by the cameras 40. The storage medium is installed inside the capsule 10. In addition, the capsule 10 further has a lighting apparatus (visible and/or infrared light), such as a lamp, for example, to assist in capturing images, the lighting apparatus being powered by a battery installed internally in the capsule 10.

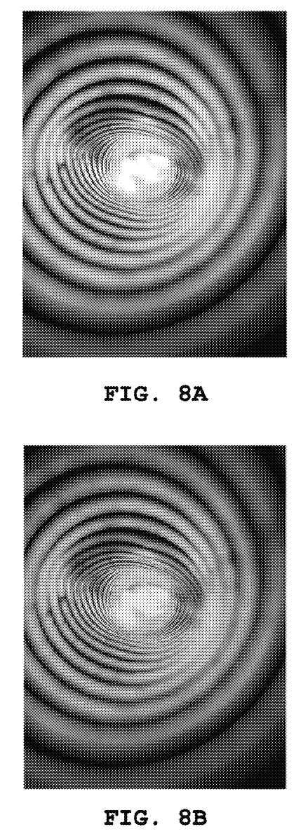

FIGS. 7A and 7B show, by way of example, images of point damages captured inside an umbilical, by means of a high-definition camera, such as that used by the device of the present disclosure. FIG. 7A presents an image with natural visible light, whereas FIG. 7B presents an image with infrared light. FIGS. 7C and 7D are schematic images that represent, respectively, an internal section of an intact umbilical and an internal section of a damaged umbilical, in which the arrow in FIG. 7D indicates the region of point damage inside the umbilical.

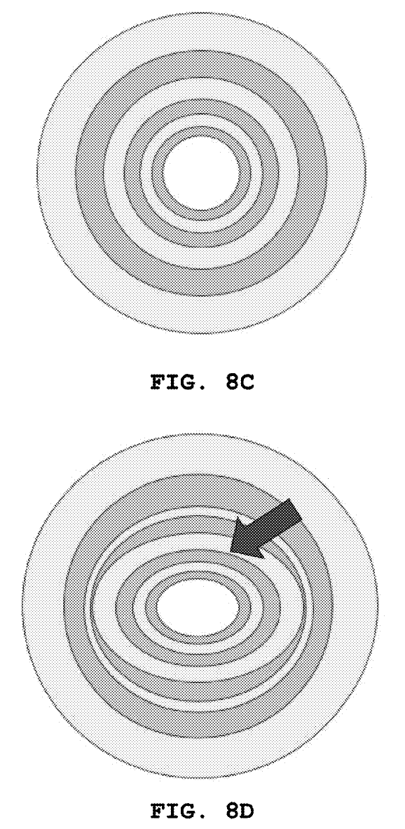

FIGS. 8A and 8B show, by way of example, images of partial collapses captured inside an umbilical, by means of a high-definition camera, such as that used by the device of the present disclosure. FIG. 8A presents an image with natural visible light, whereas FIG. 8B presents an image with infrared light. FIGS. 8C and 8D are schematic images that represent, respectively, an internal section of an intact umbilical and an internal section of a damaged umbilical, in which the arrow in FIG. 8D indicates the region of partial collapse inside the umbilical.

Based on the features described above, it can be inferred that the device of the present disclosure is a free device, capable of being pumped regardless of the length of the umbilical and its storage state (coiled, for example), which facilitates inspections both at the umbilical preparation bases and at the operational front (rigs), in the field. To this end, the device is capable of withstanding hydrostatic pressures (pumping), being waterproof, providing light (by means of a battery) and having the capacity to store high-definition images (internal memory). Furthermore, with the use of two cameras inverted in relation to each other, it is possible to view the front part and the back part of the sections that appear along the length of the umbilical, that is, even if the device is pumped in a certain direction, it is possible to obtain images from the opposite direction to allow different views in the investigation of damages that may compromise the integrity of the umbilical.

Accordingly, in a preferred aspect, the umbilical inspection device 100 comprises: a watertight capsule 10 having at least one camera 40 inside the capsule 10, in which each camera 40 has a lens 41 facing a corresponding window 11 of the capsule 10; at least three fins 20, 21, 22 of circular cross-section fixed externally and around the capsule 10, in which a central fin 21 is positioned centrally in relation to the longitudinal direction of the capsule 10 and equidistant in relation to fins 20, 22 adjacent to the central fin 21; and at least two sets of wheels 30, in which each set of wheels 30 is fixed externally and around the watertight capsule 10 in the vicinity of each end thereof.

Those skilled in the art will value the knowledge presented herein and will be able to reproduce the present disclosure in the presented aspects and in other variants, encompassed by the scope of the attached claims.

What is claimed is:

1. An umbilical inspection device, comprising:
a watertight capsule having at least one camera inside the capsule, in which each camera has a lens facing a corresponding window of the capsule;
at least three fins of circular cross-section fixed externally and around the capsule, in which a central fin is positioned centrally in relation to the longitudinal direction of the capsule and equidistant in relation to the fins adjacent to the central fin; and
at least two sets of wheels, wherein each set of wheels is fixed externally and around the watertight capsule in the vicinity of each end thereof.

2. The umbilical inspection device according to claim 1, wherein it comprises two cameras, the lenses of the cameras being positioned in opposite directions in relation to each other to capture images of both sides of the capsule.

3. The umbilical inspection device according to claim 1, wherein the fins are flexible membranes made of elastomer, being configured to bend depending on the direction of fluid pumping.

4. The umbilical inspection device according to claim 1, wherein each set of wheels has four wheels that are distributed equidistant from each other.

5. The umbilical inspection device according to claim 1, wherein the capsule has an outer diameter of 0.0127 m (0.5 inches), and the transverse distance between a wheel of the set of wheels and the wheel positioned 180 degrees from it is 0.0190 m (0.75 inches).

6. The umbilical inspection device \according to claim 1, wherein it further comprises an image storage medium for storing images captured from at least one camera.

7. The umbilical inspection device according to claim 1, wherein it further comprises an infrared light illumination apparatus.
